(19) United States
(12) Patent Application Publication
(10) Pub. No.: US 2024/0152774 A1
(43) Pub. Date: May 9, 2024

(54) PERIODICALLY COOPERATIVE MULTI-AGENT REINFORCEMENT LEARNING

(71) Applicant: X Development LLC, Mountain View, CA (US)

(72) Inventors: Lam Thanh NGUYEN, Mountain View, CA (US); Grace Taixi BRENTANO, Redwood City, CA (US); David ANDRE, San Francisco, CA (US); Salil Vijaykumar PRADHAN, San Jose, CA (US); Gearoid MURPHY, Mountain View, CA (US)

(21) Appl. No.: 17/979,964

(22) Filed: Nov. 3, 2022

(51) Int. Cl. G06N 5/02; G06N 5/04

(52) U.S. Cl. CPC G06N 5/022; G06N 5/043

(57) ABSTRACT

Disclosed herein are methods, systems, and apparatus, including computer programs encoded on a computer storage medium, for modeling agents in multi-agent systems as reinforcement learning (RL) agents and training control policies that cause the agents to cooperate towards a common goal. A method can include generating, for each of a group of simulated local agents in an agent network in which the simulated local agents share resources, information, or both, experience tuples having a state for the simulated local agent, an action taken by the simulated local agent, and a local result for the action taken, updating each local policy of each simulated local agent according to the respective local result, providing, to each of the simulated local agents, information representing a global state of the agent network, and updating each local policy of each simulated local agent according to the global state of the agent network.

### BACKGROUND

In multi-agent systems, each agent often plans and operates independently of other agents in order to maximize its own objectives. Each agent can seek optimization independent of each other, thereby trying to achieve optimal local goals for the agent. However, in certain systems, a mismatch among goals or visible local information to other agents in the multi-agent system can result in non-optimal results for the system as a whole, which in turn causes non-optimal results for the agents.

### SUMMARY

In general, an aspect of the subject matter described in this specification relates to machine learning techniques for modeling agents in multi-agent systems as reinforcement learning (RL) agents and training control policies that cause the agents to cooperate towards a common goal. More particularly, the disclosed techniques can provide for building a RL simulation framework in which each entity in a multi-agent system is represented by an RL agent. Each RL agent can collect information about the corresponding entity's status, an environment state, take actions that may represent the entity's operations, and collect reward information (e.g., operation cost(s)). These actions can form a historical experience for the entity. Historical experiences of multiple entities can be used for training the RL simulation framework. Moreover, the actions that form the historical experience for the entity may reflect operations of the entity before local information can be aggregated and shared amongst the RL agents. Before training, rewards of different agents can be calibrated so that they can be trained towards a common reward. Information aggregation and sharing can provide for the reward calibration to take place. Reward calibration may also be performed at various different times and/or frequency, such as based on a frequency at which the information is aggregated and shared among the entities. Using the disclosed techniques, the RL agents can be trained based on the calibrated rewards. As a result, the agents can cooperate periodically to share and aggregate information of their past operations such that the multi-agent system as a whole may be optimized. Although the agents can cooperate periodically, the agents may also cooperate at different times and/or intervals of time. For example, the agents can cooperate after a predetermined or threshold amount of time has passed since a last time the agents cooperated. As another example, the agents can cooperate after a predetermined or threshold number of events have occurred. Sometimes, in addition to or instead of reward calibration, the agents may communicate with each other such that their actions can be synchronized.

Simulation of multi-agent systems as described herein can allow efficient planning and replanning of control policies and operations so that multiple entities in the system can optimize their next operations, which in turn can cause an overall optimization of the system. The disclosed technology can provide for maximizing reward for all entities while also incentivizing the entities to mutually cooperate. If an entity has too much global information, for example, the entity may be greedy and take advantage of the global information, to the detriment of other entities in the system. The disclosed technology, on the other hand, provides for just enough of the global information to be shared and used for RL agent training such that all the entities can benefit from the global information. For example, the RL agents can be trained to be greedy and maximize local reward, then the disclosed technology can be used to adjust how much of the global information to share in order to maximize overall benefit to all the entities in the system. As another example, in addition to or instead of controlling how much global information is provided to the RL agents, local value functions of one or more RL agents can be adjusted using the disclosed technology. This, in turn, can affect actions of other RL agents, such that the RL agents can analyze what effects their policies may have on other agents. The one or more RL agents can tune their policies according to those effects, which in turn can cause the RL agents to trend towards globally optimal solutions.

Simulating the multi-agent system can also aid in building a flexible and resilient network. Simulations that more accurately reflect real world behavior of actual and synthetic agents in the system may provide simulated results that are more likely to reflect real world results and therefore lead to optimization of the system as a whole. Accordingly, the disclosed techniques can provide for optimizing control policies of entities that already work together (e.g., a customer may already work with a shipper and the disclosed techniques can be used to optimize a supply chain between the customer and their shipper) as well as for optimizing control policies amongst different entities (e.g., competitors).

Given the role that simulation plays, quickly building and executing a multi-agent system simulation with less effort may help run and grow entities in the system. Taking many hours of dedicated engineering time to build out a simulation may make the costs of scaling such entities uneconomical.

In some aspects, the subject matter described in this specification may be embodied in methods that may include the actions of generating, for each of a group of simulated local agents in an agent network in which the group of simulated local agents share resources, information, or both, experience tuples having a state for the simulated local agent, an action taken by the simulated local agent, and a local result for the action taken, updating each local policy of each simulated local agent according to the respective local result generated from the action taken by the simulated local agent, providing, to each of the group of simulated local agents, information representing a global state of the agent network, and updating each local policy of each simulated local agent according to the global state of the agent network.

The methods may optionally include one or more of the following features. For example, generating the experience tuples may include varying amounts of information provided to each of the group of simulated local agents. Generating the experience tuples can include varying the actions taken between one or more of the group of simulated local agents in the agent network. The method may also include receiving, from a global critic network and for each of the group of simulated local agents in the agent network, local-agent-specific information about an action that should have been taken by the simulated local agent. The method can also include providing, to each of the group of simulated local agents, the local-agent-specific information, and updating each local policy of each simulated local agent according to the local-agent-specific information.

As another example, each of the group of simulated local agents may include a global state estimator, the simulated local agent being configured to: periodically receive the information representing the global state of the agent network, process, by the global state estimator, the received information to determine global state information, and update the local policy of the simulated local agent according to the global state information of the global state estimator. Sometimes, the action taken may be a quantity of resources that the simulated local agent has available. The action taken can be a quantity of goods to be transported in the agent network.

Sometimes, the action taken can include information shared by the simulated local agent with at least one of the group of simulated local agents in the agent network. The information can be shared locally with a subset of simulated local agents in the group of simulated local agents. The information can be shared globally with the group of simulated local agents in the agent network. The information may include at least one of (i) a type of resource-related information of the simulated local agent and (ii) a threshold quantity of the resource-related information of the simulated local agent. As another example, the method can also include: determining, for each of the group of simulated local agents in the agent network, local-agent-specific information about an action that should have been taken by the simulated local agent, providing, to each of the group of simulated local agents, the local-agent-specific information, and updating each local policy of each simulated local agent according to the local-agent-specific information and the global state of the agent network. Sometimes, the agent network can be a supply chain.

In some aspects, the subject matter described in this specification may be embodied in a system having one or more computers and one or more storage devices storing instructions that are operable, when executed by the one or more computers, to cause the one or more computers to perform any of the methods described above.

In some aspects, the subject matter described in this specification may be embodied in a computer storage medium encoded with a computer program, the program having instructions that are operable, when executed by data processing apparatus, to cause the data processing apparatus to perform any of the methods described above.

The details of one or more implementations are set forth in the accompanying drawings and the description, below. Other potential features and advantages of the disclosure will be apparent from the description and drawings, and from the claims.

### BRIEF DESCRIPTION OF THE DRAWINGS

FIG. 1 illustrates a block diagram of an example system including an agent network of simulated local agents.

FIG. 2 is a flowchart of a process to train control policies of the simulated local agents in the agent network of FIG. 1 to cooperate towards a common goal.

FIG. 3 is a flowchart of a process to update the control policies of FIG. 2 based on global state information of the agent network.

FIG. 4 illustrates a block diagram of an example system in a supply chain.

FIG. 5 illustrates a schematic diagram of an exemplary generic computer system.

Like reference symbols in the various drawings indicate like elements.

### DETAILED DESCRIPTION

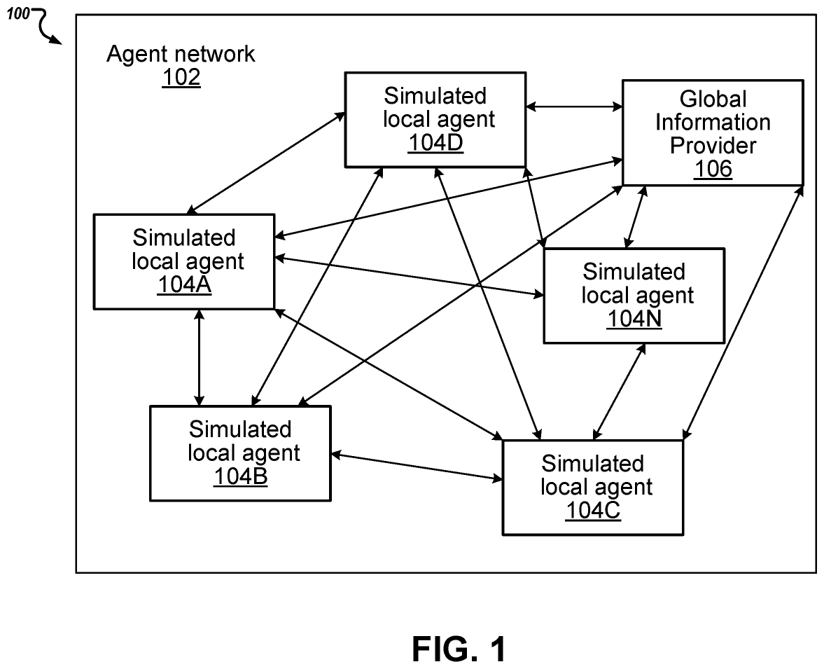

FIG. 1 illustrates a block diagram of an example system 100 including an agent network 102 of simulated local agents 104A-N. The system 100 can be used to simulate a real-world network, such as a supply chain. Accordingly, the agent network 102 can be a multi-agent system representing the real-world network, such as a supply chain. The simulated local agents 104A-N can represent entities in the real-world network. After simulating the real-world network, such as a supply chain, and obtaining sufficient results (e.g., results that satisfy some threshold level of accuracy or confidence or another threshold criteria), the results may be used to generate or otherwise update policies of the simulated local agents 104A-N. The results can also be used by a service, entity, or other system that may advise the real-world entities represented by the simulated local agents 104A-N about how to make, improve, change, or optimize their decisions in the real-world network. Such advisement (e.g., recommendations, automatic actions) can be provided by way of software that the simulated local agents 104A-N download and install. The implemented local policies can therefore be trained elsewhere. Sometimes, the results can be used by the service, entity, or other system to automatically update and/or modify decisions made by the real-world entities represented by the simulated local agents 104A-N. In the illustrative example of a supply chain, the entities can include, but are not limited to, shippers, manufacturers, suppliers, retail stores, warehouses, and/or customers. Each of the simulated local agents 104A-N can be software modules trained by reinforcement learning (RL) techniques to follow respective local policies.

The agent network 102 can also include a global information provider 106. The global information provider 106 can be a computing system, server, and/or software module configured to publish information to be used for training and updating the local policies of the simulated local agents 104A-N. For example, the global information provider 106 can generate a global critique of local performance. The global critique can, for example, indicate how a local-agent-specific-trained policy (or an updated policy of the particular simulated local agent) has deviated from a global goal. Any other local performance critiquing can be performed on a periodic basis by the global information provider 106. The global information provider 106 may additionally or alternatively critique the simulated local agents 104A-N according to their respective local information. The global critique can then be published in the agent network 12 and used for local training at the simulated local agents 104A-N. Any other global information that is collected and/or shared by the global information provider 106 can be published periodically so that the global information can be used by the simulated local agents 104A-N for training and updating their respective local policies. Publishing of the global information may also occur at other intervals of time that may or may not be regular intervals of time.

The global information provider 106 can make/generate and publish periodic global information updates. The global information updates can be generated and published whenever the global information provider 106 collects and/or receives updated information from the simulated local agents 104A-N. The global information may hide a global state of the agent network 102 and/or particular state information of each of the simulated local agents 104A-N. As a result, the agents 104A-N may not be aware of what the other agents 104A-N respective states are.

The periodic global information updates can then be published and provided to the simulated local agents 104A-N to train and update the respective local policies. A global criteria can be used for training based on the global information. Such continuous training based on periodically updated global information can provide for optimization of both the simulated local agents 104A-N and the agent network 102 as a whole. Therefore, the simulated local agents 104A-N may cooperate towards attaining a common goal that benefits all. In some implementations, a partially-observable Markov decision process (MDP) can be utilized for modeling decision-making in scenarios where outcomes are partly random and partly under control of the respective simulated local agent 104A-N. Accordingly, optimal results/outcomes can be attained by the simulated local agents 104A-N and the agent network 102 as a whole due to a desire of the simulated local agents 104A-N to be cooperative and to share just enough information to take actions that would achieve such optimal results/outcomes.

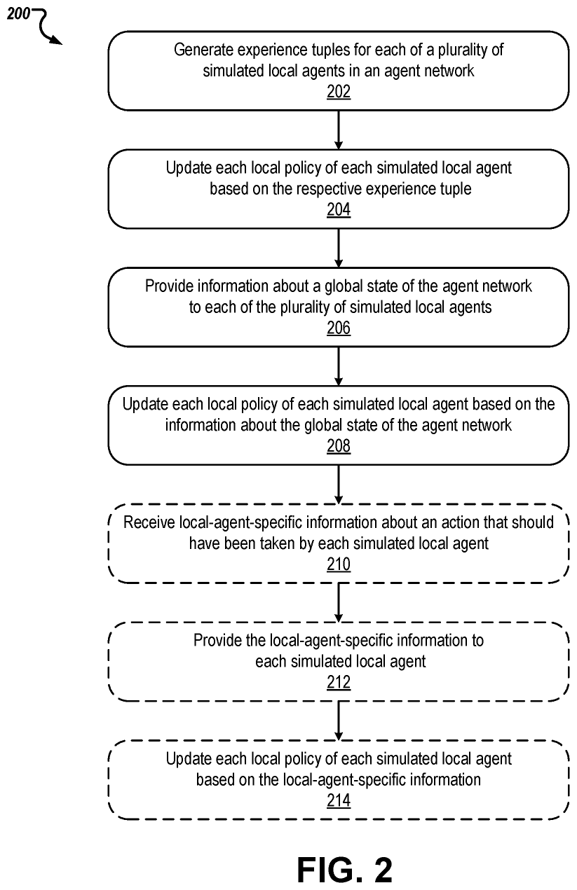

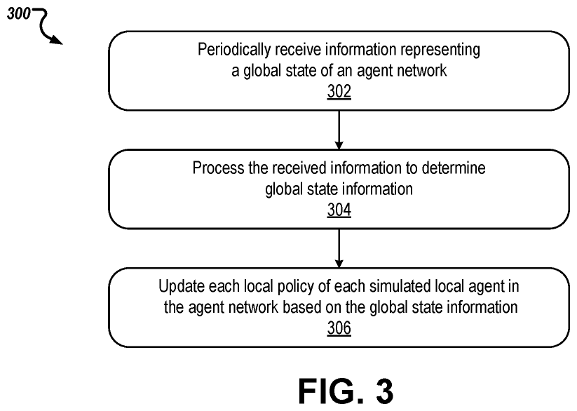

The simulated local agents 104A-N may also collect and use local-agent-specific information for training and updating the respective local policies, as described below in FIGS. 2 and 3. For example, the simulated local agents 104A-N can use, for training and updating their respective local policies, their local information as well as an estimate of a global story for the agent network 102 that indicates how the particular agent's actions/contributions affect a global estimate for the agent network 102. The simulated local agents 104A-N can additionally receive updates from the global information provider 106 indicating a real story for the agent network 102 indicating how the particular agent's actions actually affect the global estimate for the agent network 102. These updates can be used to further adjust and/or refine the respective local policies of the simulated local agents 104A-N to optimize results/outcomes (e.g., reward) for the respective simulated local agents 104A-N as well as the agent network 102 as a whole.

The simulated local agents 104A-N can be trained with RL techniques to update their respective local policies based on available global information, periodically updated global information, global critiques, information shared between one or more of the simulated local agents 104A-N, other local-agent-specific information, or any combination thereof. Any combination of these inputs can be used to determine and maximize (e.g., optimize) rewards for each of the simulated local agents 104A-N to benefit the individual simulated local agents 104A-N as well as the agent network 102 as a whole. Advantageously, any combination of these inputs can be used to determine how much information to share amongst the simulated local agents 104A-N to optimize rewards for all in the agent network 102.

In some implementations, trust aspects can also be integrated into the agent network 102 to ensure that verified global information (and other information shared amongst the simulated local agents 104A-N) is being shared amongst the simulated local agents 104A-N. For example, block chain technology (e.g., contracts) can be used to establish public trust amongst the simulated local agents 104A-N sharing information in the agent network 102. By establishing public trust, the simulated local agents 104A-N can reliably train and update local policies based on the verified global information that is published and/or shared within the agent network 102, thereby benefitting each of the simulated local agents 104A-N as well as the agent network 102 as a whole.

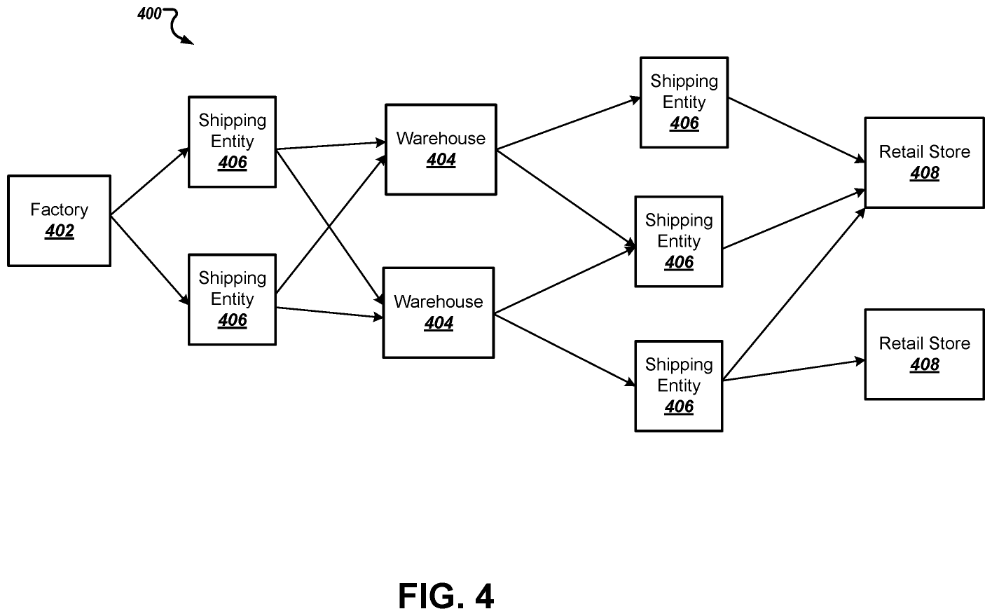

FIG. 2 is a flowchart of a process 200 to train control policies of the simulated local agents in the agent network of FIG. 1 to cooperate towards a common goal. The process 200 can be used to model the agents with RL techniques in a multi-agent system (the agent network) and to train control policies of the agents that cause the agents to cooperate towards the common goal in the multi-agent system. As an illustrative example, the agent network described herein can be a supply chain and the simulated local agents can represent one or more entities in the supply chain, including but not limited to factories, warehouses, shipping companies, retail stores, customers, suppliers, and/or competitors. Refer to FIG. 4 for an example supply chain network for which the disclosed techniques can be implemented.

The process 200 can be performed by any appropriate system of one or more computers in one or more locations, e.g., the system 100 described above. The process 200 can also be performed by one or more other computing systems and/or networks programmed in accordance with this disclosure.

Referring to the process 200, a plurality of experience tuples can be generated for each of a plurality of simulated local agents in an agent network (block 202). The plurality of simulated local agents can share resources, information or both in the agent network. The experience tuples can include a state for the simulated local agent, an action taken by the simulated local agent, and/or a local result for the action taken.

The action taken can include a quantity of resources that the simulated local agent has available. The action taken can additionally or alternatively include a quantity of goods to be transported in the agent network (in an example scenario in which the agent network represents a supply chain). Additionally or alternatively, the action taken can include information shared by the simulated local agent with at least one of the plurality of simulated local agents in the agent network. The information can be shared locally with a subset of the simulated local agents in the plurality of simulated local agents. The information can additionally or alternatively be shared globally with the plurality of simulated local agents in the agent network. In some implementations, the information can include at least one of (i) a type of resource-related information of the simulated local agent and (ii) a threshold quantity of the resource-related information of the simulated local agent.

Generating the plurality of experience tuples can include varying amounts of information provided to each of the plurality of simulated local agents. Generating the plurality of experience tuples can additionally or alternatively include varying the actions taken between one or more of the plurality of simulated local agents in the agent network.

In block 204, each local policy of each simulated local agent can be updated based on the respective experience tuple. Each local policy may be updated after each respective experience tuple is generated. In some implementations, local policies of the simulated local agents can be updated in batches. For example, each local policy can be updated according to the respective local result generated from the action taken by the simulated local agent. Each of the simulated local agents can take actions in accordance with local policy. Using RL techniques, the local policy can be updated to optimize results based on those actions taken.

In block 206, information about a global state of the agent network can be provided to each of the plurality of simulated local agents.

Each local policy of each simulated local agent can then be updated based on the information about the global state of the agent network (block 208). In other words, a reinforcement learning model (e.g., the local policy) that is implemented by the simulated local agent can be updated. As a result, the simulated local agent can optimize its respective local policy as well as facilitate optimization of the agent network as a whole.

Optionally, local-agent-specific information about an action that should have been taken by each simulated local agent can be received in block 210. In some implementations, a global critic network can generate the local-agent-specific information. The global critic network can be similar to the agent network described herein. The global critic network can, however, be configured to determine what actions the simulated local agents should have taken in the agent network. In some implementations, multiple critic networks can generate the local-agent-specific information for the plurality of simulated local agents in the agent network. In some implementations, in block 210, the local-agent specific information can be determined by the system 100 or any other computing system and/or server described herein. In yet some implementations, the local-agent-specific information can be determined by the respective simulated local agent (refer to FIG. 3 for further discussion).

The local-agent-specific information can optionally be provided to each simulated local agent in block 212.

In block 214, each local policy of each simulated local agent can optionally be updated based on the local-agent-specific information. Therefore, the simulated local agents can update their local policies based on the actions that they should have taken, as determined by the global critic network. The local policies can be updated based on the respective experience tuple(s), global state information, local-agent-specific information, or any combination thereof. As a result, the local policies can be optimized to benefit not only the individual simulated local agents but also the agent network as a whole. Therefore, the simulated local agents can cooperate and work towards a common goal that benefits all in the agent network.

FIG. 3 is a flowchart of a process 300 to update the control policies of FIG. 2 based on global state information of the agent network. The process 300 can be performed by the system 100 described above. The process 300 can also be performed by one or more other computing systems and/or networks described throughout this disclosure.

Referring to the process 300, information representing a global state of an agent network (refer to the agent network in FIG. 2) can be periodically received in block 302. The information can be received from the global information provider 106 described in reference to FIG. 1, for example.

The received information can be processed to determine global state information in block 304. For example, each simulated local agent in the agent network can receive the information representing the global state of the agent network and then process that information to determine the global state information. Each simulated local agent can include a global state estimator. The global state estimator can be configured to process the information to determine the global state information. In some implementations, the global information provider 106 in FIG. 1 can process the information to determine the global state information in block 304.

Each local policy of each simulated local agent in the agent network can be updated based on the global state information in block 306.

Any one or more of the blocks 302, 304, and 306 can be performed by each simulated local agent in the agent network. Therefore, each simulated local agent can process globally available information and local-agent-specific information in order to optimize its respective local policy. In so doing, the disclosed techniques can provide for benefitting the simulated local agent as well as the agent network as a whole.

FIG. 4 illustrates a block diagram of an example system 400 in a supply chain. The system 400 is an illustrative use case in which the techniques described above in reference to FIGS. 1-3 can be implemented. The system 400 can represent a real-world supply chain in which multiple entities interact in the supply chain. Using the disclosed techniques, the entities can be identified and then simulated with local agents in an agent network. Local control policies of the identified entities can be adjusted, updated, or otherwise modified according to results from simulating the local agents in the agent network. The updated local control policies can then be run with the simulated local agents to determine what types of decisions and/or actions the corresponding real-world entities should take. The real-world entities can be advised of those types of decisions and/or actions to take. The supply chain can be monitored to determine whether the real-world entities make those advised decisions and/or actions. If those advised decisions and/or actions are taken, then the supply chain can be optimized and the multiple real-world entities can mutually benefit.

In the example system 400, multiple entities can interact with each other in the supply chain. For example, a factory 402 can produce or otherwise supply goods (e.g., products, items, produce) that can be transported to one or more warehouses 404 by one or more shipping entities 406. The one or more warehouses 404 may also provide the goods to one or more retail stores 408 via the one or more shipping entities 406. One or more additional, fewer, or other entities may also interact with each other in the supply chain. The disclosed techniques can be used to optimize outcomes, results, and/or rewards for each of the individual entities 402, 406, 404, and 408 in the supply chain.

As shown in the example of FIG. 4, multiple entities can be at competition with each other to provide their services to other entities in the supply chain. The competing entities can include, but are not limited to, the shipping entities 406, the warehouses 404, and/or the retail stores 408. The disclosed techniques may also be used to optimize outcomes, results, and/or results for overall global success of the supply chain in the system 400, regardless of whether and how many entities are competing with each other in the supply chain.

As an illustrative example, one of the shipping entities 406 can be a trucking company. The trucking company may publish information locally, that information indicating that the trucking company has between 5 and 10 trucks available. Other local entities, such as the factory 402, warehouses 404, and/or retail stores 408, may use this information for purposes of training and updating their respective local policies to optimize their individual rewards (refer to FIGS. 1-3 for further discussion about training and updating local policies). Moreover, the trucking company can provide other information to their specific partner, such as a first warehouse 404, indicating that it actually has 6 trucks available. This other information can be used by the trucking company and the first warehouse to further optimize their particular rewards. As a result, various entities in the supply chain can optimize their rewards based on available information in order to benefit themselves as well as the supply chain as a whole.

The information shared between entities in the supply chain can also vary depending on actions taken or actions to be taken by the entities. For example, those actions can include, but are not limited to, decisions about what goods to ship or transport, where to ship those goods, quantities of the goods to ship, other information about the goods, where to store goods, what goods to store, quantities of goods to store, etc. The actions may also include information to send one or more decisions to various entities in the supply chain.

As an illustrative example, the factory 402 can publish information to be used by the shipping entities 406 indicating a state of the factory 402. For example, the information can indicate that the factory 402 needs to ship a non-fragile good from point A to point B. Although this information does not indicate what the good is, the information still conveys a need of the factory 402 to ship the non-fragile good, which is enough information for the shipping entities 406 to schedule their deliveries accordingly. Although the shipping entities 406 receive limited information, they can optimize their rewards using the disclosed techniques without taking advantage of larger amounts of information being disclosed and shared by the factory 402. Using the disclosed techniques, both the factory 402 and the shipping entities 406 can benefit and optimize their rewards by sharing some information but not all information concerning the states of the involved entities.

FIG. 4 is merely an illustrative use case of the disclosed techniques. The disclosed techniques can be implemented in a software platform, which can be used by various other types of entities in various other multi-agent networks/systems. The entities can use the disclosed techniques to cooperate with each other to reach a common goal (e.g., optimize the multi-agent network/system as a whole) while optimizing their respective rewards without sharing all their information. The disclosed techniques can be used to scale profit-making up and down, to decide how much information to share between entities, and to help both contracting entities and competitors to optimize their rewards and optimize the supply chain or other multi-agent network/system as a whole. The disclosed techniques may also be used to assist entities in integrating reputation and trust in their information-sharing, publish information on behalf of other entities in the network/system, and/or publish additional information about a global state of the network/system to further assist the entities in optimizing their respective rewards as well as optimizing the network/system as a whole.

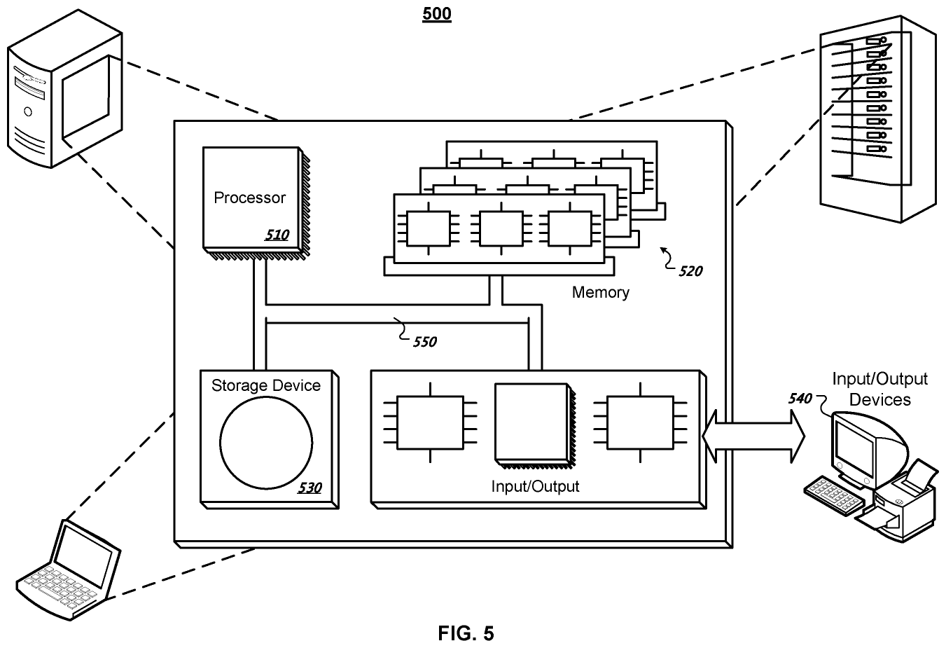

FIG. 5 illustrates a schematic diagram of an exemplary generic computer system 500. The systems 100 and 400 described above may be implemented on the system 500.

The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, a solid state drive, an optical disk device, a tape device, universal serial bus stick, or some other storage device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a rail trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other. The servers may be part of a cloud, which may include ephemeral aspects.

What is claimed is:

1. A computer-implemented method comprising:
generating, for each of a plurality of simulated local agents in an agent network in which the plurality of simulated local agents share resources, information, or both, a plurality of experience tuples comprising a state for the simulated local agent, an action taken by the simulated local agent, and a local result for the action taken;
updating each local policy of each simulated local agent according to the respective local result generated from the action taken by the simulated local agent;
providing, to each of the plurality of simulated local agents, information representing a global state of the agent network; and
updating each local policy of each simulated local agent according to the global state of the agent network.

2. The computer-implemented method of claim 1, wherein generating the plurality of experience tuples comprises varying amounts of information provided to each of the plurality of simulated local agents.

3. The computer-implemented method of claim 1, wherein generating the plurality of experience tuples comprises varying the actions taken between one or more of the plurality of simulated local agents in the agent network.

4. The computer-implemented method of claim 1, further comprising receiving, from a global critic network and for each of the plurality of simulated local agents in the agent network, local-agent-specific information about an action that should have been taken by the simulated local agent.

5. The computer-implemented method of claim 4, further comprising:
providing, to each of the plurality of simulated local agents, the local-agent-specific information; and
updating each local policy of each simulated local agent according to the local-agent-specific information.

6. The computer-implemented method of claim 1, wherein each of the plurality of simulated local agents comprises a global state estimator, the simulated local agent configured to:
periodically receive the information representing the global state of the agent network;
process, by the global state estimator, the received information to determine global state information; and
update the local policy of the simulated local agent according to the global state information of the global state estimator.

7. The computer-implemented method of claim 1, wherein the action taken is a quantity of resources that the simulated local agent has available.

8. The computer-implemented method of claim 1, wherein the action taken is a quantity of goods to be transported in the agent network.

9. The computer-implemented method of claim 1, wherein the action taken is information shared by the simulated local agent with at least one of the plurality of simulated local agents in the agent network.

10. The computer-implemented method of claim 9, wherein the information is shared locally with a subset of simulated local agents in the plurality of simulated local agents.

11. The computer-implemented method of claim 9, wherein the information is shared globally with the plurality of simulated local agents in the agent network.

12. The computer-implemented method of claim 9, wherein the information includes at least one of (i) a type of resource-related information of the simulated local agent and (ii) a threshold quantity of the resource-related information of the simulated local agent.

13. The computer-implemented method of claim 1, further comprising:
determining, for each of the plurality of simulated local agents in the agent network, local-agent-specific information about an action that should have been taken by the simulated local agent;
providing, to each of the plurality of simulated local agents, the local-agent-specific information; and
updating each local policy of each simulated local agent according to the local-agent-specific information and the global state of the agent network.

14. The computer-implemented method of claim 1, wherein the agent network is a supply chain.

15. A system comprising:
one or more computers; and
one or more storage devices storing instructions that are operable, when executed by the one or more computers, to cause the one or more computers to perform operations comprising:
generating, for each of a plurality of simulated local agents in an agent network in which the plurality of simulated local agents share resources, information, or both, a plurality of experience tuples comprising a state for the simulated local agent, an action taken by the simulated local agent, and a local result for the action taken;
updating each local policy of each simulated local agent according to the respective local result generated from the action taken by the simulated local agent;
providing, to each of the plurality of simulated local agents, information representing a global state of the agent network; and
updating each local policy of each simulated local agent according to the global state of the agent network.

16. The system of claim 15, wherein each of the plurality of simulated local agents comprises a global state estimator, the simulated local agent configured to:
periodically receive the information representing the global state of the agent network;
process, by the global state estimator, the received information to determine global state information; and
update the local policy of the simulated local agent according to the global state information of the global state estimator.

17. The system of claim 15, wherein the action taken is information shared by the simulated local agent with at least one of the plurality of simulated local agents in the agent network.

18. A computer storage medium encoded with a computer program, the program comprising instructions that are operable, when executed by data processing apparatus, to cause the data processing apparatus to perform operations comprising:
generating, for each of a plurality of simulated local agents in an agent network in which the plurality of simulated local agents share resources, information, or both, a plurality of experience tuples comprising a state for the simulated local agent, an action taken by the simulated local agent, and a local result for the action taken;
updating each local policy of each simulated local agent according to the respective local result generated from the action taken by the simulated local agent;
providing, to each of the plurality of simulated local agents, information representing a global state of the agent network; and
updating each local policy of each simulated local agent according to the global state of the agent network.

19. The computer storage medium of claim 18, wherein each of the plurality of simulated local agents comprises a global state estimator, the simulated local agent configured to:
periodically receive the information representing the global state of the agent network;
process, by the global state estimator, the received information to determine global state information; and
update the local policy of the simulated local agent according to the global state information of the global state estimator.

20. The computer storage medium of claim 18, wherein the action taken is information shared by the simulated local agent with at least one of the plurality of simulated local agents in the agent network.
